(19) United States
(12) Patent Application Publication
(10) Pub. No.: US 2018/0173729 A1
(43) Pub. Date: Jun. 21, 2018

(54) MICROSERVICE ARCHITECTURE FOR AN ANALYTIC DATA ACCESS LAYER

(71) Applicant: SAP SE, Walldorf (DE)

(72) Inventor: Tobias Weller, Buseck (DE)

(21) Appl. No.: 15/387,080

(22) Filed: Dec. 21, 2016

(51) Int. Cl. G06F 17/30

(52) U.S. Cl. CPC G06F 17/30294; G06F 17/30867; G06F 17/30578

(57) ABSTRACT

The present disclosure involves systems, software, and computer implemented methods for using microservices to analyze a data source. One example method includes: providing, in a data access layer, a set of multiple independent microservices for analyzing data provided by a data providing system, including a browsing service that enables selection of a data source included in the data providing system, a model service that enables viewing and modifying a model of the data source, and a result set service that enables retrieval of data from the data source; executing, in response to a first request, the browsing service, including providing a description of a selected data source; executing, in response to a second request, the model service, including providing a model description; and executing, in response to a third request, the result set service, including asynchronously providing data corresponding to the model description.

### TECHNICAL FIELD

The present disclosure relates to computer-implemented methods, software, and systems for using microservices to analyze a data source.

### BACKGROUND

A data access layer can be used by an application to access a data source. A data source can be a file, a database, or some other type of data source. The data access layer can handle connecting to the data source on behalf of the application. The data access layer can hide complexity of the data source from the application. The application can be written to interface with the data access layer rather than directly with the data source, which can allow the data source to be replaced with another data source, while requiring minimal or no changes to the application.

### SUMMARY

The present disclosure involves systems, software, and computer implemented methods for using microservices to analyze a data source. One example method includes providing, in a data access layer, a set of multiple independent microservices for analyzing data provided by a data providing system, including a browsing service that enables selection of a data source included in the data providing system, a model service that enables viewing and modifying a model of the data source, and a result set service that enables retrieval of data from the data source in accordance with the model; executing, in response to a first request, the browsing service, including providing a description of a selected data source; executing, in response to a second request, the model service, including providing a model description, the second request including the description of the selected data source; and executing, in response to a third request, the result set service, including asynchronously providing data corresponding to the model description, the third request including the model description.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for using microservices to analyze a data source.

FIG. 2 is a software model of a browsing package.

FIG. 3 is a flowchart of an example method for performing a search using filters.

FIG. 4 is a flowchart of an example method for using a browsing service.

FIG. 5 is a software model of a model package.

FIG. 6 is a flowchart of an example method for generating and using a model description.

FIG. 7 is a software model of a result set service package.

FIG. 8 is a software model of a value help service package.

FIG. 9 is a flowchart of an example method for using an input handler.

FIG. 10A is a block diagram illustrating a client workflow.

FIG. 10B is an example user interface for selecting a data source.

FIG. 10C is an example user interface for displaying model information.

FIG. 10D is an example user interface for selecting one or more values.

FIG. 10E is an example user interface for displaying data from a result set.

FIG. 11 is a flowchart of an example method for using microservices to analyze a data source.

### DETAILED DESCRIPTION

Data analysts may desire to use client applications to analyze data of data providing systems. A data access layer can be provided that includes multiple independent microservices that can be used by clients. The multiple independent microservices can each perform a discrete service and can be written so as to not execute any of the other microservices. The client can implement an application by calling different microservices to build functionality of the client. The microservices can be configured to use a common data format, meaning that an output of one microservice can be used as an input to another microservice. Outputs can be provided asynchronously, which can enable the caller to process results more quickly as compared to systems that return results synchronously. The microservices can include a browsing service that enables selection of a data source included in the data providing system, a model service that enables viewing and modifying a model of the data source, and a result set service that enables retrieval of data from the data source in accordance with the model. Other microservices can be included. For example, a value help service can enable the retrieving of values from elements belonging to a data source for filtering the data source.

Providing functionality as a set of multiple independent microservices can provide several advantages as compared to a single interconnected API (Application Programming Interface). A developer can learn and use the specific functionality of one microservice without having to understand a large API that includes multiple interfaces. Independent microservices can be more easily maintained than an API that includes multiple, dependent workflows. New microservices can be added without requiring any changes to existing microservices, which can be different as compared to changes to the implementation of an API that may be required when adding a new service to a single API that has dependent workflows. Large, interdependent APIs may not support asynchronous processing. Asynchronous providing of outputs by the independent microservices can enable faster processing, such as more responsive user interfaces as compared to APIs that return results synchronously. A client of the data access layer can implement functionality by selecting and calling a particular combination of microservices that collectively implement a particular solution, which can be a more flexible approach as compared to using a workflow that may be predefined by an API.

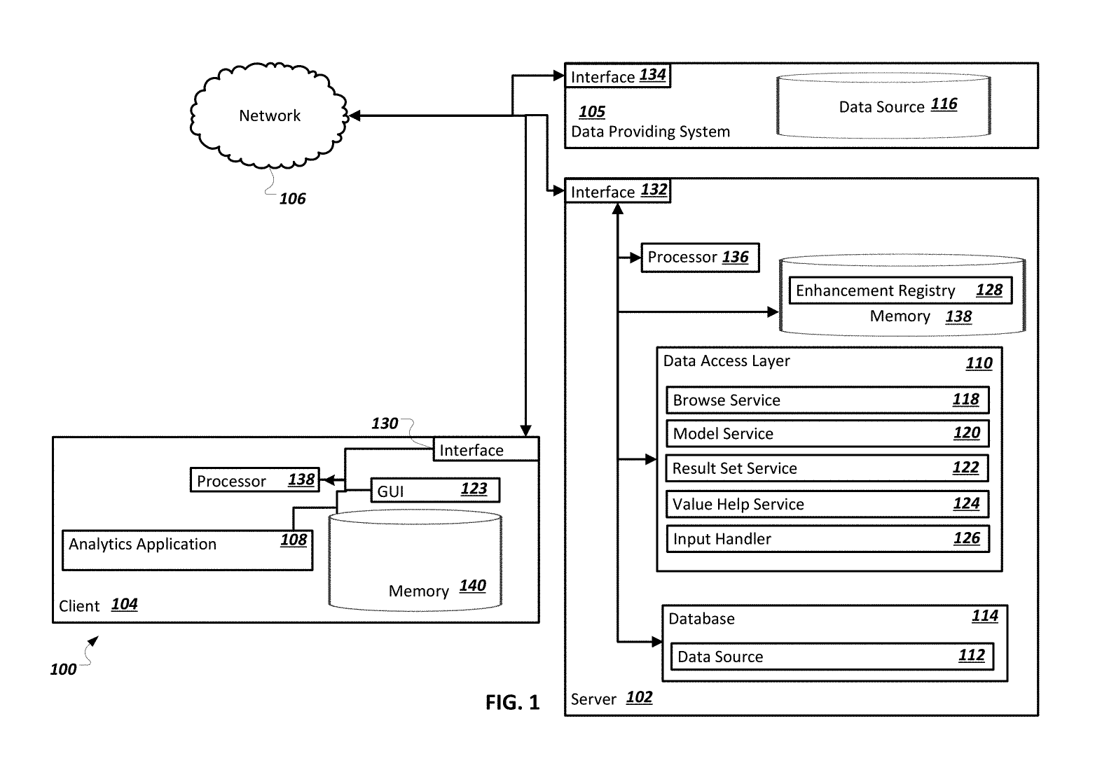

FIG. 1 is a block diagram illustrating an example system 100 for using microservices to analyze a data source. Specifically, the illustrated system 100 includes or is communicably coupled with a server 102, a client device 104, one or more data providing systems 105, and a network 106. Although shown separately, in some implementations, functionality of two or more systems or servers may be provided by a single system or server. In some implementations, the functionality of one illustrated system or server may be provided by multiple systems or servers.

A user can use an analytics application 108 on the client device 104 to analyze data included in a data source. The analytics application 108 can be configured to interface, as a client program, with a data access layer 110 running on the server 102. In some implementations, the data access layer 110 is installed and executed locally on the client device 104. The data access layer 110 can connect, on behalf of the analytics application 108, to a local data source 112 in a local database 114 on the server 102 or to an external data source 116 on an external data providing system 105.

The analytics application 108 can be configured to use multiple, independent microservices provided by the data access layer 110. The data access layer 110 can include a browsing service 118 that enables selection of a data source included in a respective system, a model service 120 that enables viewing and modifying a model of the selected data source, and a result set service 122 that enables retrieval of data from the data source in accordance with the model, for use in the analytics application 108.

The browsing service 118 can enable a user of the analytics application 108 to search for data sources in a particular system (e.g. in the database 114 or in an external data providing system 105). The browsing service 118 can accept one or more filters to be used in the search. The results of the search can be provided asynchronously to the analytics application 108, which can enable a GUI 123 of the analytics application to be updated before all search results have been provided to the analytics application 108. The browsing service 118 can provide a data source description of a selected data source to the analytics application 108, for use in other services.

The model service 120 can enable a user of the analytics application 108 to view and modify a model description associated with a selected data source. The analytics application 108 can provide a previously-received data source description to the model service 120, and receive, from the model service 120, a model description of the selected data source. The analytics application 108 can provide the model description to the result set service 122, to obtain data associated with the model. The result set service 122 can asynchronously provide data to the analytics application 108, which can enable the GUI 123 to be updated before all of the requested data has been received by the analytics application 108.

The model service 120 can also enable a user of the analytics application 108 to select a subset of a presented model, or to modify a presented model, to create a modified model description. The analytics application 108 can provide the modified model description to the result set service 122, to obtain data corresponding to the modified model. The analytics application 108 can allow a user to select one or more current values of a model entity, such as a dimension, to modify a model description. The analytics application 108 can call a value help service 124 to obtain the current values of the entity. Some models may include, as part of a model definition, one or more prompts that require input, such as to populate one or more parameters, before the model can be used. An input handler interface 126 can be defined by the analytics application 108 for obtaining input for the prompt(s), such as from the GUI 123.

The services included in the data access layer 110 can be stateless, in that no state is stored in a given service between calls of the given service. Also, no state is directly shared by the multiple independent services. The services can be configured to use a common data format, meaning that an output of one service can be used as an input to another service. For example, a data source description output of the browsing service 118 can be used as an input to the model service 120, and a model description output of the model service 120 can be used as an input to the result set service 122. While an output of one service can be used as input to another service, an output of a given service is generally not used or referenced by the given service after being outputted. The common data format can be JSON (JavaScript Object Notation) or some other format.

The data access layer 110 can enable enhancements to be made to some or all of the independent services. An enhancement can be a feature that is applicable to certain scenarios, data sources, or implementations. The data access layer 110 can include pre-defined enhancements for supported systems. A user, such as the developer of the analytics application 108, can define other, custom enhancements. An enhancement can have an associated description, which can be stored in an enhancement registry 128. The enhancement registry 128 can be used to identify a requested enhancement or to provide information about available enhancements.

As used in the present disclosure, the term “computer” is intended to encompass any suitable processing device. For example, although FIG. 1 illustrates a single server 102, and a single client device 104, the system 100 can be implemented using a single, stand-alone computing device, two or more servers 102, or two or more client devices 104. Indeed, the server 102 and the client device 104 may be any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the server 102 and the client device 104 may be adapted to execute any operating system, including Linux, UNIX, Windows, Mac OS®, Java™, Android™, iOS or any other suitable operating system. According to one implementation, the server 102 may also include or be communicably coupled with an e-mail server, a Web server, a caching server, a streaming data server, and/or other suitable server.

Interfaces 130, 132, and 134 are used by the client device 104, the server 102, and the one or more external data sources 105, respectively, for communicating with other systems in a distributed environment—including within the system 100—connected to the network 106. Generally, the interfaces 130, 132, and 134 each comprise logic encoded in software and/or hardware in a suitable combination and operable to communicate with the network 106. More specifically, the interfaces 130, 132, and 134 may each comprise software supporting one or more communication protocols associated with communications such that the network 106 or interface's hardware is operable to communicate physical signals within and outside of the illustrated system 100.

The server 102 includes one or more processors 136. Each processor 136 may be a central processing unit (CPU), a blade, an application specific integrated circuit (ASIC), a field-programmable gate array (FPGA), or another suitable component. Generally, each processor 136 executes instructions and manipulates data to perform the operations of the server 102. Specifically, each processor 136 executes the functionality required to receive and respond to requests from the client device 104, for example.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, JavaScript®, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The server 102 includes memory 138. In some implementations, the server 102 includes multiple memories. The memory 138 may include any type of memory or database module and may take the form of volatile and/or non-volatile memory including, without limitation, magnetic media, optical media, random access memory (RAM), read-only memory (ROM), removable media, or any other suitable local or remote memory component. The memory 138 may store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the server 102.

The client device 104 may generally be any computing device operable to connect to or communicate with the server 102 via the network 106 using a wireline or wireless connection. In general, the client device 104 comprises an electronic computer device operable to receive, transmit, process, and store any appropriate data associated with the system 100 of FIG. 1. The client device 104 can include one or more client applications, including the analytics application 108. A client application is any type of application that allows the client device 104 to request and view content on the client device 104. In some implementations, a client application can use parameters, metadata, and other information received at launch to access a particular set of data from the server 102. In some instances, a client application may be an agent or client-side version of the one or more enterprise applications running on an enterprise server (not shown).

The client device 104 further includes one or more processors 138. Each processor 138 included in the client device 104 may be a central processing unit (CPU), an application specific integrated circuit (ASIC), a field-programmable gate array (FPGA), or another suitable component. Generally, each processor 138 included in the client device 104 executes instructions and manipulates data to perform the operations of the client device 104. Specifically, each processor 138 included in the client device 104 executes the functionality required to send requests to the server 102 and to receive and process responses from the server 102.

The client device 104 is generally intended to encompass any client computing device such as a laptop/notebook computer, wireless data port, smart phone, personal data assistant (PDA), tablet computing device, one or more processors within these devices, or any other suitable processing device. For example, the client device 104 may comprise a computer that includes an input device, such as a keypad, touch screen, or other device that can accept user information, and an output device that conveys information associated with the operation of the server 102, or the client device 104 itself, including digital data, visual information, or the GUI 123.

The GUI 123 of the client device 104 interfaces with at least a portion of the system 100 for any suitable purpose, including generating a visual representation of the analytics application 108. In particular, the GUI 123 may be used to view and navigate various Web pages, or other user interfaces. Generally, the GUI 123 provides the user with an efficient and user-friendly presentation of business data provided by or communicated within the system. The GUI 123 may comprise a plurality of customizable frames or views having interactive fields, pull-down lists, and buttons operated by the user. The GUI 123 contemplates any suitable graphical user interface, such as a combination of a generic web browser, intelligent engine, and command line interface (CLI) that processes information and efficiently presents the results to the user visually.

Memory 140 included in the client device 104 may include any memory or database module and may take the form of volatile or non-volatile memory including, without limitation, magnetic media, optical media, random access memory (RAM), read-only memory (ROM), removable media, or any other suitable local or remote memory component. The memory 140 may store various objects or data, including user selections, caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the client device 104.

There may be any number of client devices 104 associated with, or external to, the system 100. For example, while the illustrated system 100 includes one client device 104, alternative implementations of the system 100 may include multiple client devices 104 communicably coupled to the server 102 and/or the network 106, or any other number suitable to the purposes of the system 100. Additionally, there may also be one or more additional client devices 104 external to the illustrated portion of system 100 that are capable of interacting with the system 100 via the network 106. Further, the term “client”, “client device” and “user” may be used interchangeably as appropriate without departing from the scope of this disclosure. Moreover, while the client device 104 is described in terms of being used by a single user, this disclosure contemplates that many users may use one computer, or that one user may use multiple computers.

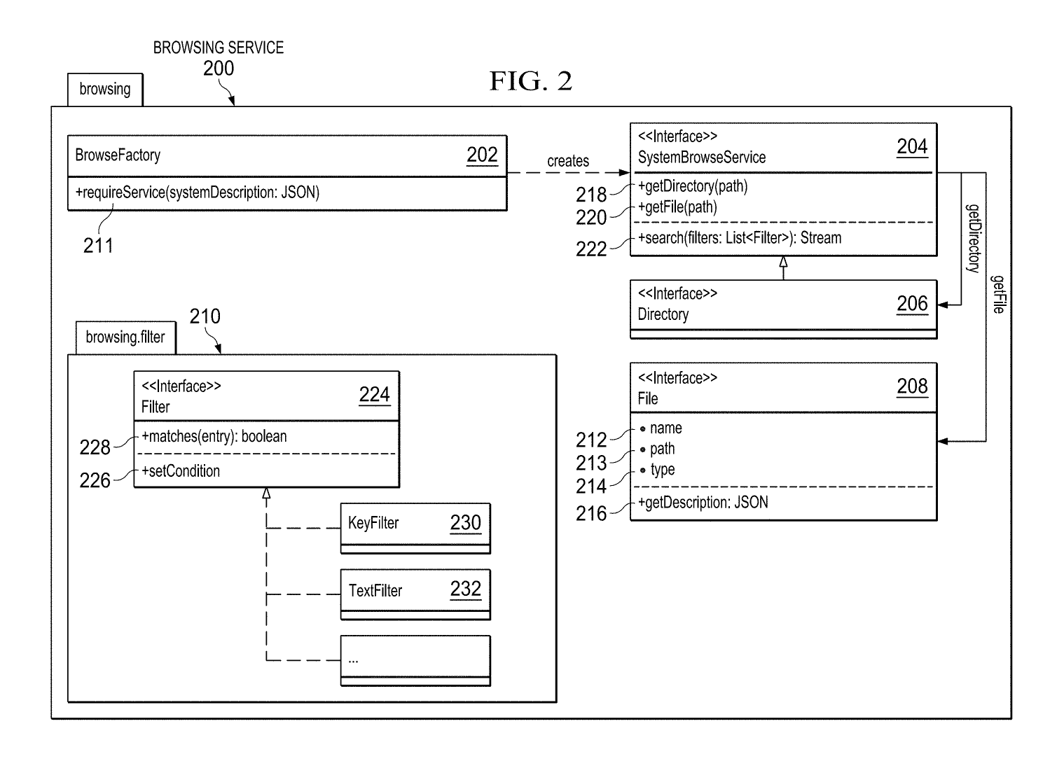

FIG. 2 is a software model of a browsing package 200. The browsing package 200 includes a BrowseFactory class 202, a SystemBrowseService interface 204, a Directory interface 206, a File interface 208, and a browsing.filter package 210. A requireService method 211 of the BrowseFactory class 202 can be used to create an instance of the SystemBrowseService interface 204.

A client can use an instance of the SystemBrowseService interface 204 for discovering available objects in a specified system. The system can be specified by a system description that is provided to the requireService method 211. The system can be a data center, for example. The system description can include details for how to connect to the system, such as a URL (Uniform Resource Locator), port, user name, user authorization information, or other connection information.

A system can include various objects, such as database views, database tables, queries, information providers, and other data sources. Objects can exist in a directory within the system. A directory can include other directories. The client can use the SystemBrowseService instance to search for particular types of objects that are included in the system. A directory in the system can be represented by an instance of the Directory interface 206. An object in the system can be represented by an instance of the File interface 208. The File interface 208 defines name 212, path 213, and type 214 attributes, and a getDescription method 216.

The SystemBrowseService interface 204 defines a getDirectory method 218 and a getFile method 220. The getDirectory method 218 returns an instance of the Directory interface 206. The getFile method 220 returns an instance of the File interface 208. A client can use the getDirectory method 218 or the getFile method 220 to get a representation of a directory or object if the client knows the path of a respective directory or object. The representation of the directory or object can be in a JSON format and can be used as an input to other services.

The SystemBrowseService interface 204 defines a search method 222. The client can use the search method 222 to get representations of system objects that match one or more filters. The search method 222 can return matching objects asynchronously in a stream. The client can separately process respective matching objects as they are provided to the client in the stream. The client can render information about the matching objects in a user interface, for example. Since the matching objects are streamed asynchronously, the user interface can be rendered as matching objects are received, without a need to wait for all matching objects to be provided. Such asynchronous processing can result in a more responsive user interface, as compared to a synchronous operation in which the client waits for all matching objects to be found before processing any matching objects.

An input to the search method 222 can be a list of filters. A filter can be represented by a Filter interface 224. The Filter interface 224 defines a setCondition method 226 that can be used to set a matching condition for the filter. A matches method 228 can be used by the SystemBrowseService interface 204 to determine whether a given object matches a filter. A KeyFilter specialization 230 and a TextFilter specialization 232 are examples of predefined filters that can be used to search for objects by object identifier and textual description, respectively. Other custom filters can be added. If multiple filters are provided to the search method 222 in a list of filters, each filter in the list can be applied sequentially to potentially reduce a matching object result set according to the matching condition of each respective filter.

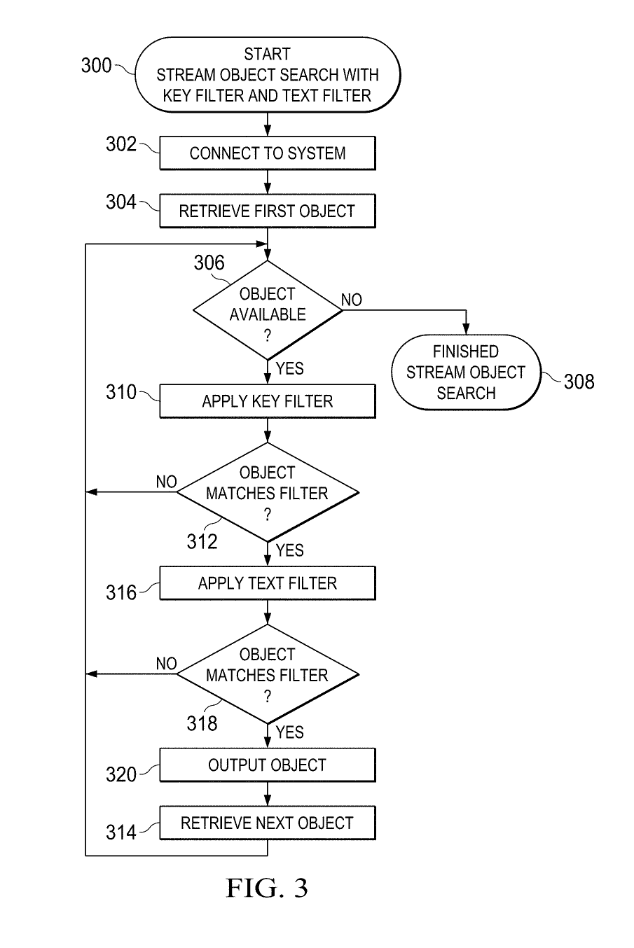

FIG. 3 is a flowchart of an example method 300 for performing a search using filters. It will be understood that method 300 and related methods may be performed, for example, by any suitable system, environment, software, and hardware, or a combination of systems, environments, software, and hardware, as appropriate. For example, one or more of a client, a server, or other computing device can be used to execute method 300 and related methods and obtain any data from the memory of a client, the server, or the other computing device. In some implementations, the method 300 and related methods are executed by one or more components of the system 100 described above with respect to FIG. 1. For example, the method 300 and related methods can be executed by the server 102 of FIG. 1.

At 302, a connection to the system is established. The connection can be established using a system description provided by the client. The system description can include a reference of a system directory in which to search.

At 304, a first object is retrieved. A first object in the specified directory can be retrieved, for example, if the directory includes at least one object.

At 306, a determination is made as to whether the retrieved object is available. If the directory does not include any objects, a first object may not be available, for example. If the directory includes at least one object, the first object can be available.

At 308, if the retrieved object is not available, the search ends. The directory may not include any objects, or may not include a next object, for example.

At 310, if the retrieved object is available, a key filter is applied. The key filter can be a first filter in a list of filters that is provided with a search request. The key filter can be a custom filter or a predefined filter that is used to find objects that have a key that matches a specified condition.

At 312, a determination is made as to whether the retrieved object matches the key filter. A determination can be made as to whether the retrieved object matches the condition of the key filter.

At 314, if the retrieved object does not match the key filter, an attempt is made to retrieve a next object, and the method 300 proceeds to step 306, as described above.

At 316, if the retrieved object matches the key filter, a text filter is applied. The text filter can be a second filter in the list of filters provided with the search request.

At 318, a determination is made as to whether the object matches the text filter. A determination can be made as to whether the retrieved object matches the condition of the text filter.

At 320, if the object matches the text filter, the object is outputted. The outputted object matches both filters included in the list of filters provided with the search request.

After the object is outputted, or if the object does not match the text filter, an attempt is made to retrieve a next object, at 314, and method 300 proceeds to step 306 as described above.

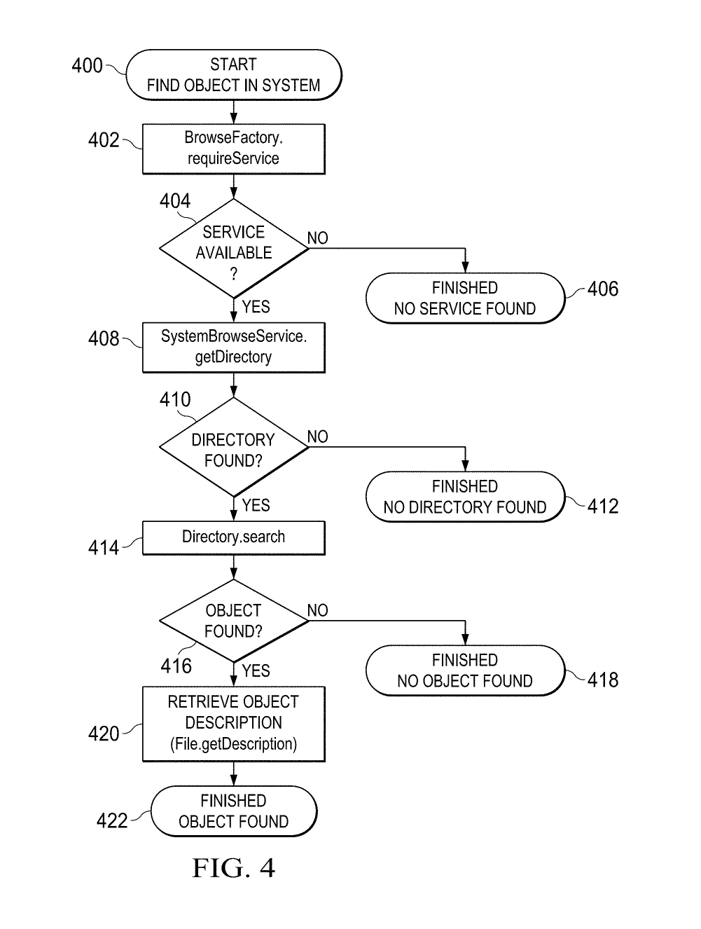

FIG. 4 is a flowchart of an example method 400 for using a browsing service. It will be understood that method 400 and related methods may be performed, for example, by any suitable system, environment, software, and hardware, or a combination of systems, environments, software, and hardware, as appropriate. For example, one or more of a client, a server, or other computing device can be used to execute method 400 and related methods and obtain any data from the memory of a client, the server, or the other computing device. In some implementations, the method 400 and related methods are executed by one or more components of the system 100 described above with respect to FIG. 1. For example, the method 400 and related methods can be executed by the server 102 of FIG. 1.

At 402, a BrowseFactory.requireService method is invoked to create an instance of the SystemBrowseService interface.

At 404, a determination is made as to whether the system browse service is available.

At 406, if the system browse service is not available, the browsing service ends with a “no service found” result.

At 408, if the service is available, a SystemBrowseService.getDirectory method is invoked to browse to a directory specified in the requireService method call.

At 410, a determination is made as to whether the directory was found during the getDirectory method call.

At 412, if the directory was not found, the browsing service ends with a “no directory found” result.

At 414, if the directory was found, a search method is invoked to search for an object within the directory. As described above for method 300, one or more filters which may have been included in the search method call can be used to specify one or more conditions to use to identify the object when searching for the object.

At 416, a determination is made as to whether the object was found using the search method.

At 418, if the object was not found, the browsing service ends with a “no object found” result.

At 420, if the object was found, an object description is retrieved. The object description can be retrieved using a File.getDescription method.

At 422, after the object description is retrieved, the method ends with an “object found” result. The object description can be used by the caller of the browsing service (e.g., a client), for displaying information about the object in a user interface. As another example, the object description can be used as input to one or more other services.

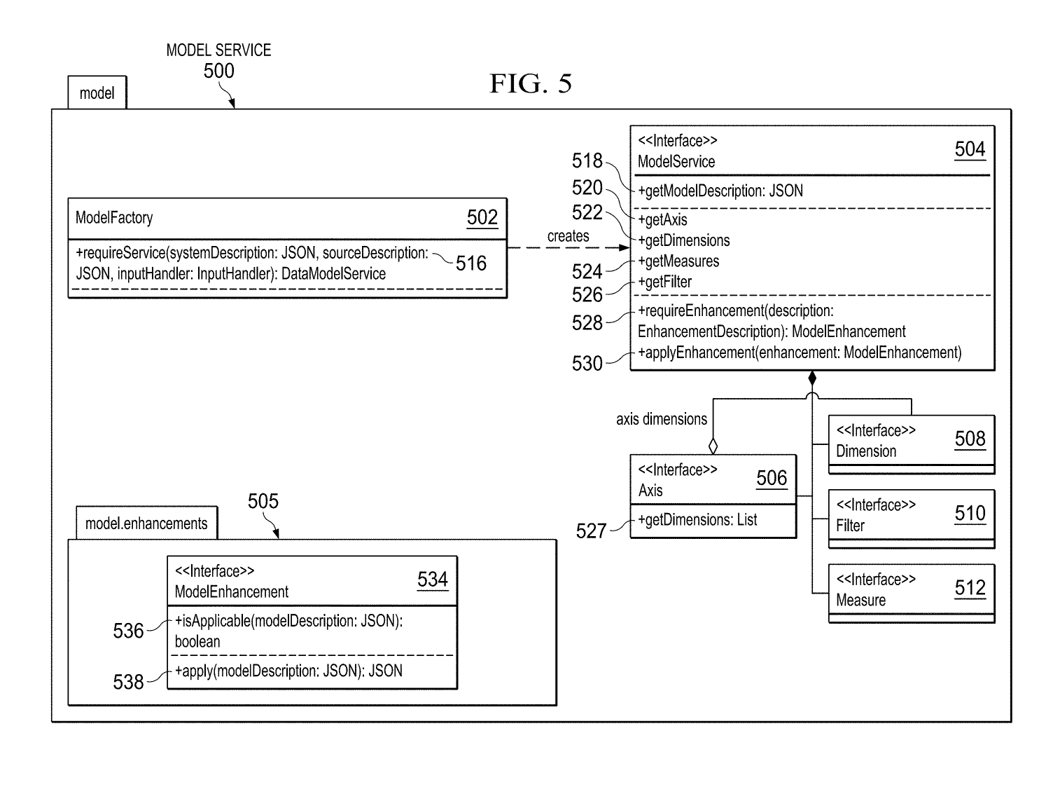

FIG. 5 is a software model of a model package 500. The model package 500 includes a ModelFactory class 502, a ModelService interface 504, and a model.enhancements package 505. An instance of the ModelService interface 504 can include one or more instances of an Axis interface 506, one or more Dimension interfaces 508, a Filter interface 510, and a Measure interface 512. A model can have multiple axes, such as rows, columns, and filters, for example. A requireService method 516 of the ModelFactory class 502 can be used to create an instance of the ModelService interface 504.

A client can use an instance of the ModelService interface 504 to obtain meta data for a data source object, such as a query, view, table, or some other type of data source object. The client can provide a data source description that identifies the data source object for which meta data is requested. The data source description can be data that is obtained by the client using an output of the system browse service described above. The data source description can be provided as an input to the requireService method 516. A system description can also be provided when creating the ModelService instance. The system description can be an output obtained from the system browse service described above.

The data source object can be a multi-dimensional data source that can be described using dimensions, axes, and measures. An axis is an element that includes dimensions and/or measures that can be used for structuring a drill down operation for a model. A data source can include multiple axes. For example, a data source can have a rows axis and a columns axis. As another example, a data source can include a free and/or a filter Axis for dimensions that are not included in a drill down data set but can be used for filtering. The axes of a data source can define the structure of a result set.

A dimension is a structure that categorizes facts and measures in order to enable users to answer business questions. Dimensions can include people, products, place and time. In a data warehouse, dimensions can provide structured labeling information to otherwise unordered numeric measures. A dimension is a data set composed of individual, non-overlapping data elements. Dimensions can be used to provide filtering, grouping and labelling. Measures provide values that can be reported on in a data source. Examples measures include quantity, amount, or number of items. Measures can form a data portion of a data source.

The ModelService interface 504 defines a getModelDescription method 518, a getAxis method 520 (which can return an Axis interface 506 instance), a getDimension method 522 (which can return a Dimension interface 508 instance), a getMeasures method 524 (which can return the Measure interface 512 instance), and a getFilter method 526 (which can return a Filter interface 510 instance). A Filter instance can be used, for example, to filter a dimension of the model. The Axis interface 506 defines a getDimensions method 527 that returns dimensions associated with the axis. The getAxis method can accept no parameters, which can indicate a request for all axes, or can accept a parameter that indicates an axis to retrieve.

As described in more detail below, the client can use one or more of the getDimension method 522, the getAxis method 520, or the getMeasures method 524 to obtain information about the model of the specified data source object. The client can modify the obtained information to create a modified model, which can temporarily represent, for example, a subset of data that the client is interested in. The modifications can be applied to a copy of the model description maintained by the ModelService instance without changing the underlying data source. The client can call the getModelDescription method 518 to get a description of the modified model and can provide the description of the modified model to another service, such as a result set service, to get data from the data source corresponding to the modified model.

Some data sources may have features that are not represented by the predefined ModelService interface 504. The ModelService interface 504 defines a requireEnhancement method 528 and an applyEnhancement method 530 that can be used to add an enhancement to the ModelService interface instance to represent a feature that may be available in a given data source and not common to all data sources. An instance of a ModelEnhancement interface 534, included in the model.enhancements package 505, can be provided to the applyEnhancement method 530 to describe an enhancement to apply to the model. The ModelEnhancement interface 534 defines an isApplicable method 536 and an apply method 538. The client can define other enhancements by implementing a custom implementation of the ModelEnhancment interface 534.

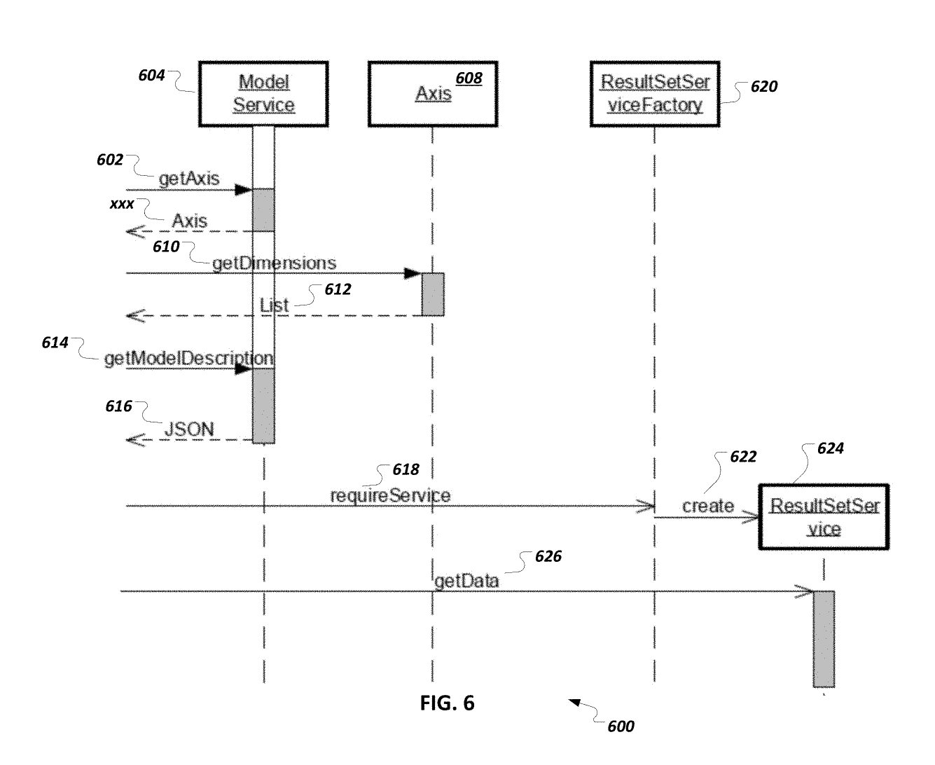

FIG. 6 is a flowchart of an example method 600 for generating and using a model description. It will be understood that method 600 and related methods may be performed, for example, by any suitable system, environment, software, and hardware, or a combination of systems, environments, software, and hardware, as appropriate. For example, one or more of a client, a server, or other computing device can be used to execute method 600 and related methods and obtain any data from the memory of a client, the server, or the other computing device. In some implementations, the method 600 and related methods are executed by one or more components of the system 100 described above with respect to FIG. 1. For example, the method 600 and related methods can be executed by the server 102 of FIG. 1.

At 602, a client invokes a getAxis method of a previously created Model Service object 604. At 606, the Model Service object 604 performs the getAxis method and returns a reference to an Axis object 608 to the client. At 610, the client invokes a getDimensions method of the Axis object 608. At 612, the Axis object 608 performs the getDimensions method and returns a list of dimensions to the client. The client can modify the obtained axis and/or one or more of the obtained dimensions, to generate a temporary model description that represents a model of interest for the client.

At 614 the client invokes a getModelDescription method of the Model Service object 604 to obtain a description of the modified model. At 616, the Model Service object 604 performs the getModelDescription method to generate a model description and returns a representation of the modified model description to the client. The representation can be in a JSON format.

At 618, the client invokes a requireService method of a Result Set Service class 620 to request a Result Set instance that can be used to retrieve data corresponding to the modified model. The description of the modified model is included as an input to the requireService method.

At 622, the Result Set Service Factory class 622 creates a Result Set Service object 624 based on the modified model description and returns a reference to the Result Set Service object 624 to the client. At 626, the client invokes a getData method of the Result Set Service object 624. The Result Set Service object 624 can stream data to the client in response to the getData call.

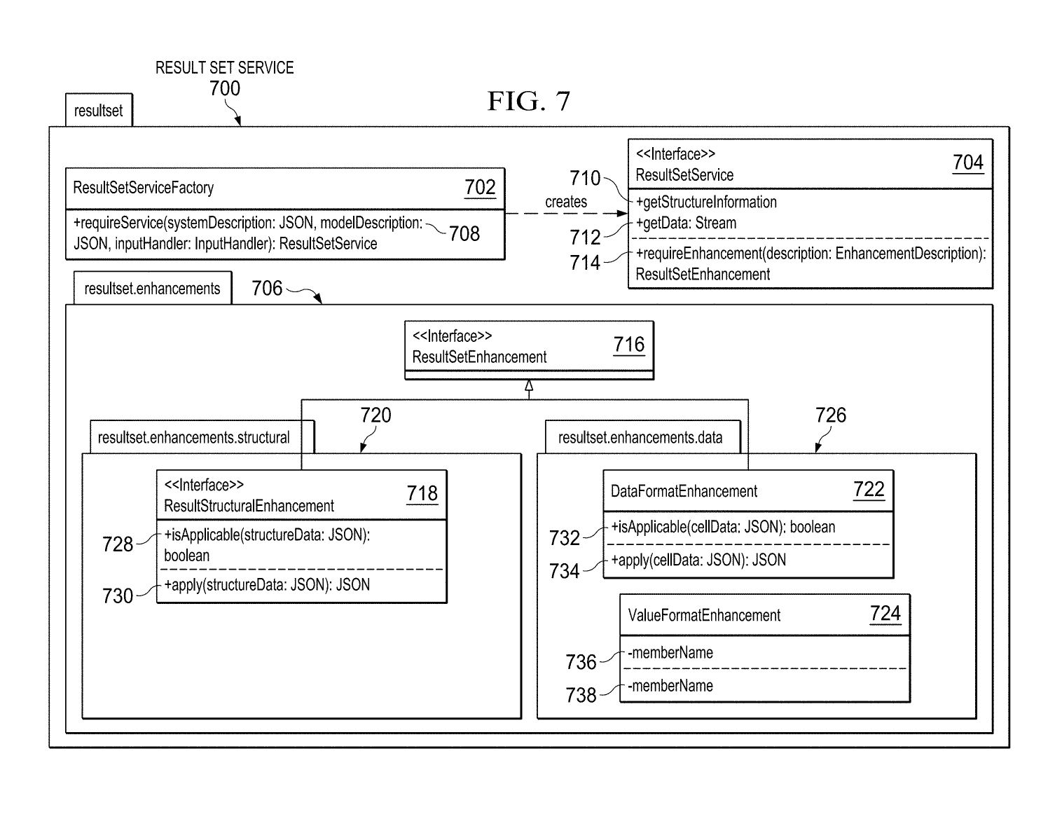

FIG. 7 is a software model of a result set service package 700. The result set service package 700 includes a ResultSetServiceFactory class 702, a ResultSetService interface 704, and a resultset.enhancements package 706. A requireService method 708 of the ResultSetServiceFactory class 702 can be used to create an instance of the ResultSetService interface 704. An instance of the ResultSetService interface 704 includes a getStructureInformation method 710, a getData method 712, and a requireEnhancement method 714.

The ResultSetService interface 704 can be used to retrieve result set data for a given model description, such as a model description obtained using the model service described above. The requireService method 708 accepts a model description as an input, for example. The client can use an output of the model service as an input when creating a ResultSetService instance. A system description can also be provided when creating the ResultSetService instance. The system description can be an output obtained from the system browse service described above.

The client can use the getData method 712 to retrieve data represented by the result set. Data can be provided asynchronously as a stream, allowing the client to process a partial set of data before all data is provided, which can result in a more responsive user interface as compared to the client having to wait until all data associated with the result set is provided. The client can call the getStructureInformation method 710 to retrieve structural information associated with the result set. Structural information can include information about the layout of the data included in the result set (e.g., number of rows and columns) which can be used by the client for determining how to render the retrieved data.

The requireEnhancement method returns an instance of a ResultSetEnhancement interface 716 included in the resultset.enhancements package 706. An instance of the ResultSetEnhancement interface can be either an instance of a ResultSetStructuralEnhancement interface 718 included in a resultset.enhancements.structural package 720 or a DataFormatEnhancement instance 722 or a ValueFormatEnhancement instance 724 included in a resultset.enhancements.data package 726. Other enhancement interfaces can be defined by the client and associated with the ResultSetEnhancement interface 716.

An instance of the ResultSetStructuralEnhancement interface 718 includes an isApplicable method 728 and an apply method 730. An instance of the DataFormatEnhancement interface 722 includes an isApplicable method 732 and an apply method 734. An instance of the ValueFormatEnhancement interface 724 includes an isApplicable method 736 and an apply method 738.

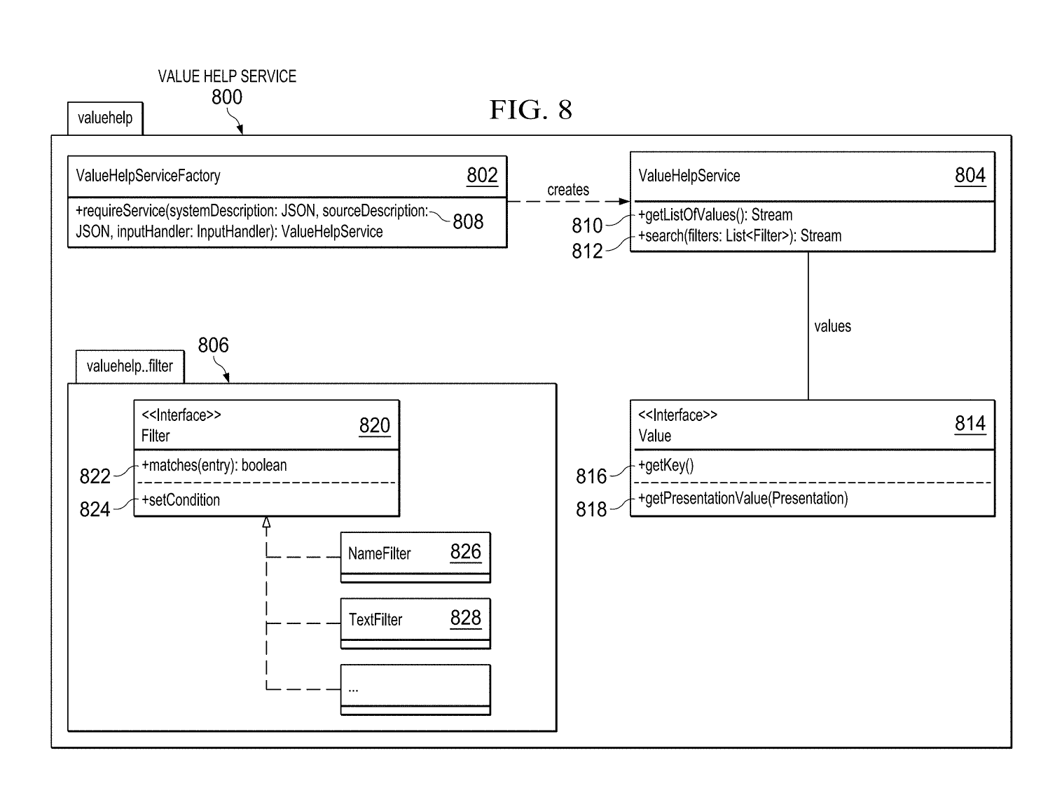

FIG. 8 is a software model of a value help service package 800. The value help service package 800 includes a ValueHelpServiceFactory class 802, a ValueHelpService interface 804, and a valuehelp.filter package 806. A requireService method 808 of the ValueHelpServiceFactory class 802 can be used to create an instance of the ValueHelpService interface 804. The ValueHelpService instance can be used to browse and search for values of a model entity. A model entity can be a dimension and the ValueHelpService can be used to browse for and search values of the dimension. As another example, a model entity can be an input-enabled object that is associated with a prompt. The ValueHelpService instance can be used to obtain a list of predefined valid values for the prompt. The requireService method 808 can accept a description of an entity for which values are to be returned.

An instance of the ValueHelpService interface 804 includes a getListOfValues method 810 that can be used to get a list of values associated with the entity. A search method 812 can be used to search for particular values in the list of values associated with the entity. The getListofValues method 810 and the search method 812 can asynchronously return a stream of Value instances defined by a Value interface 814. The Value interface 814 defines a getKey method 816 and a getPresentationValues method 818.

The valuehelp.filter package 806 includes a Filter interface 820. The Filter interface 820 defines a matches method 822 and a setCondition method 824. A NameFilter interface 826 and a TextFilter interface 828 are specializations of the Filter interface 820. Other Filter specializations can be added. Filter objects can be used with the ValueHelpService instance in a manner similar to Filter use with the browse service.

Some data sources can be defined in part by one or more prompts. A prompt can be an indicator that the data source requires an input value, such as to be used as an input parameter for an aspect of the data source, before the data source is to be used. Services that use a particular data source can be configured to accept a reference to an input handler instance which is responsible for obtaining input to be supplied for the one or more prompts. A client of the service provides the implemented input handler. If the service encounters a situation in which input is required for the data source, the service can invoke a method of the input handler to obtain the input. The service can invoke the input handler multiple times, as often as is needed, and at a time when the input is needed (as compared to obtaining input ahead of time, before it is needed, which can result in unnecessary requests for input). A calling of an event handler can be dependent upon an input received from a previous event handler—the event handler may or may not be called, based on the input received from the previous event handler.

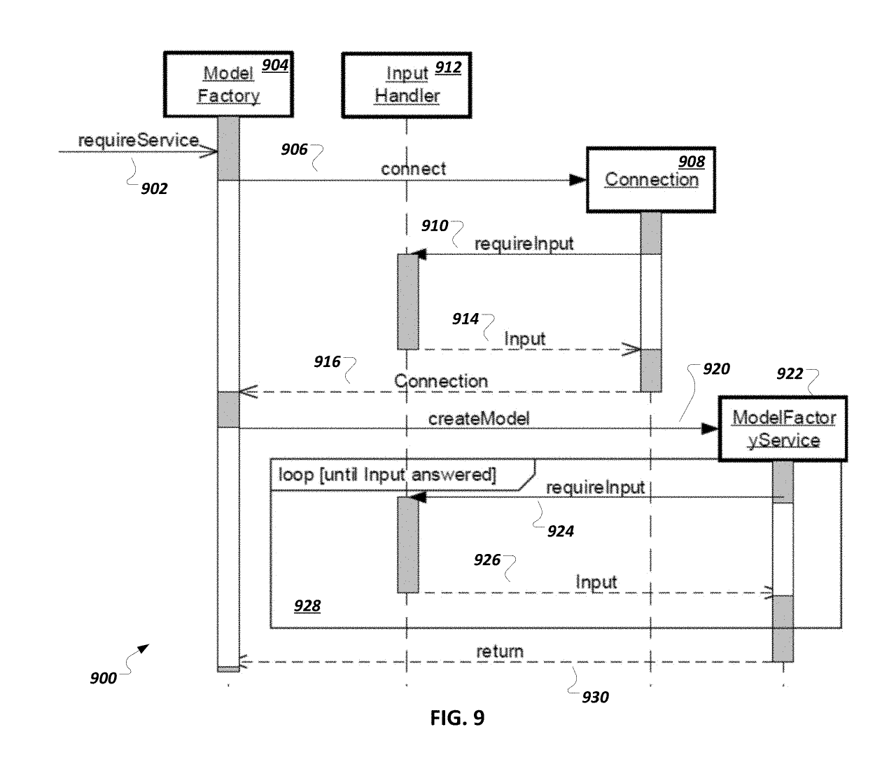

FIG. 9 is a flowchart of an example method 900 for using an input handler. It will be understood that method 900 and related methods may be performed, for example, by any suitable system, environment, software, and hardware, or a combination of systems, environments, software, and hardware, as appropriate. For example, one or more of a client, a server, or other computing device can be used to execute method 900 and related methods and obtain any data from the memory of a client, the server, or the other computing device. In some implementations, the method 900 and related methods are executed by one or more components of the system 100 described above with respect to FIG. 1. For example, the method 900 and related methods can be executed by the server 102 of FIG. 1.

At 902, a client invokes a requireService method of a Model Factory class 904. At 906, as part of performing the requireService method, the Model Factory class 904 calls a connect method of a Connection object 908 that is included in the requireService input parameters. At 910, the Connection object 908 calls a requireInput method of an InputHandler object 912. The InputHandler object 912 obtains input (e.g., from the user) and provides, at 914, the obtained input to the Connection object 908, for configuration of the Connection object 908. At 916, a reference to the configured Connection object 908 is returned to the Model Factory class 904.

At 920, the Model Factory class 904 calls a createModel method of a ModelFactoryService class 922. At 924, the ModelFactoryService class 922 calls a requireInput method of the InputHandler object 912, in response to determining that additional input is needed before the model can be created. The InputHandler object 912 obtains input (e.g., from the user) and provides, at 926, the obtained input to the ModelFactoryService class 922, for configuration of a Model object. As indicated by an iteration construct 928, the ModelFactoryService class 922 can call the InputHandler object 912 multiple times for multiple input items. At 930, the ModelFactoryService class 922 returns a configured Model instance to the ModelFactory class 904. The configured Model instance can be provided to the client in response to the requireService method call.

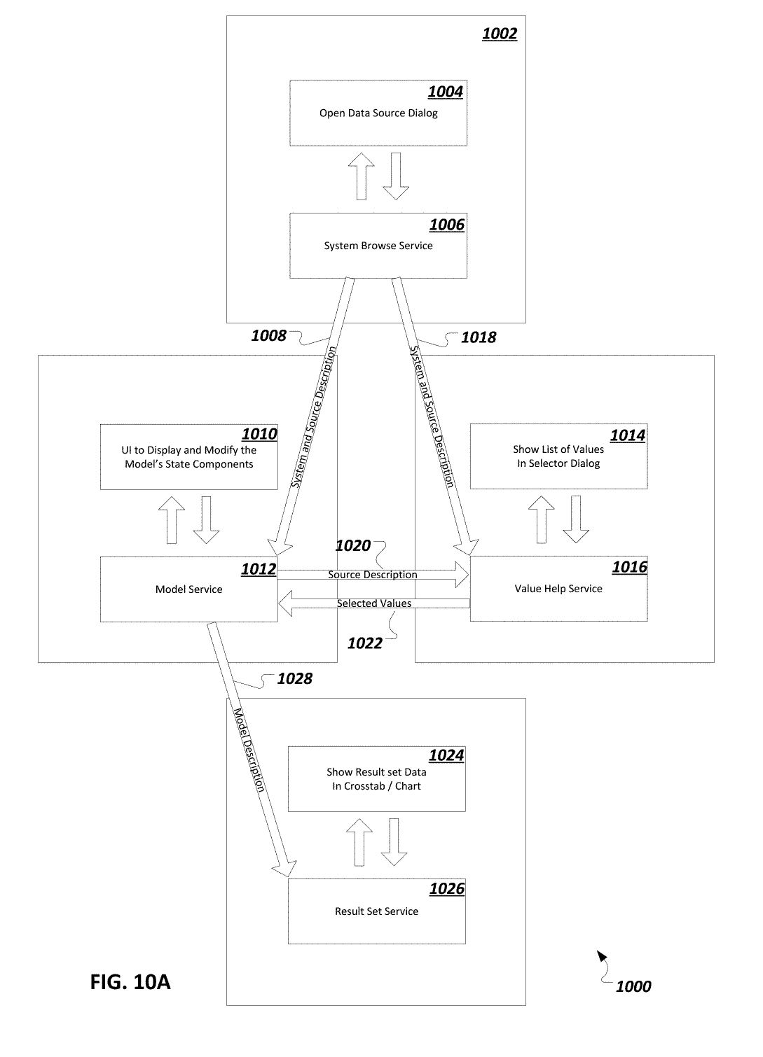

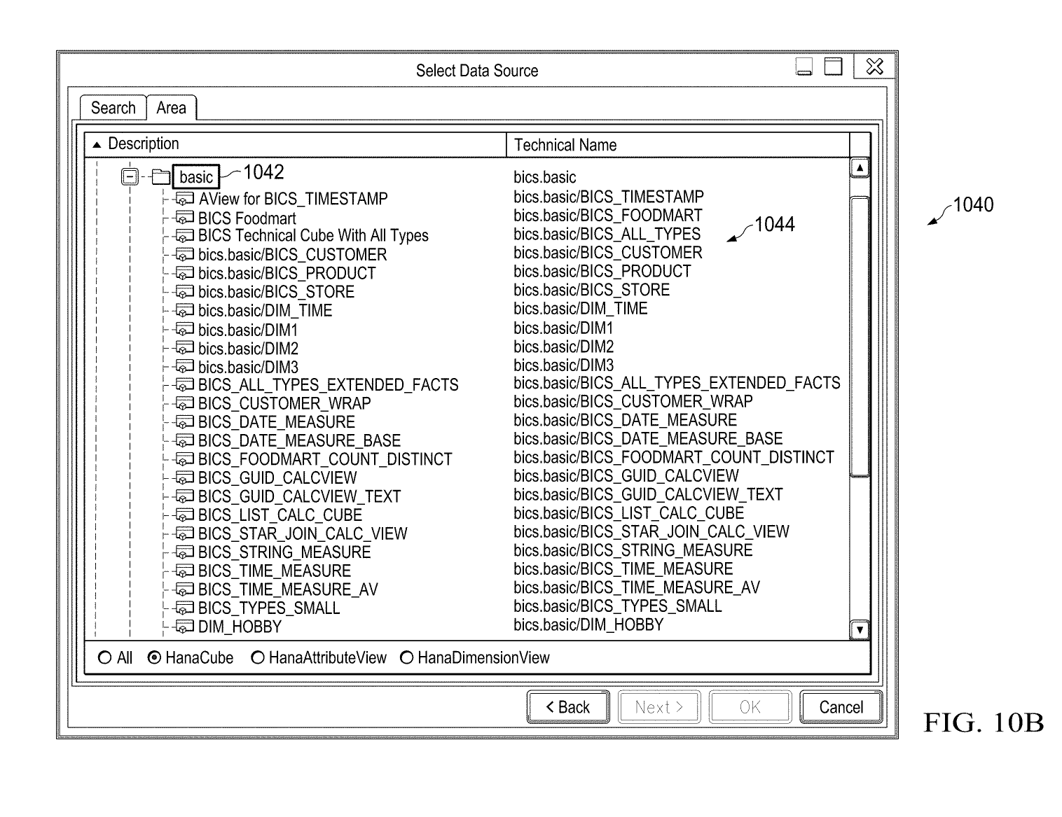

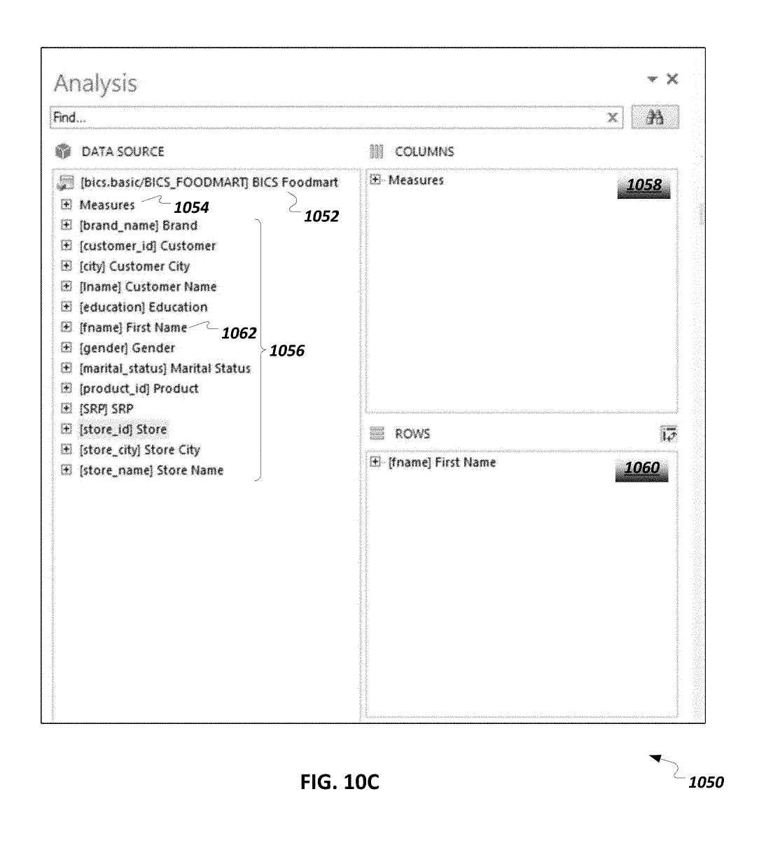

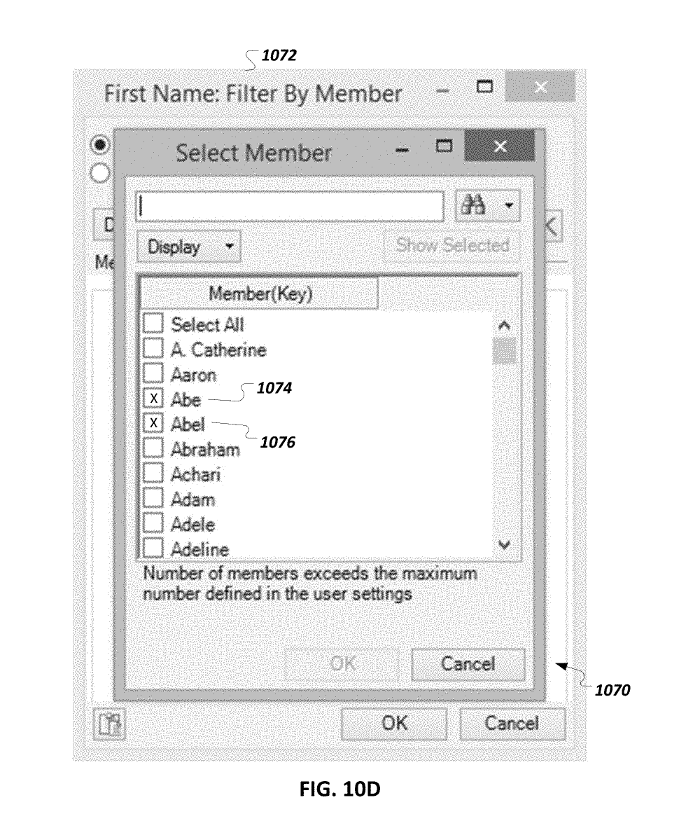

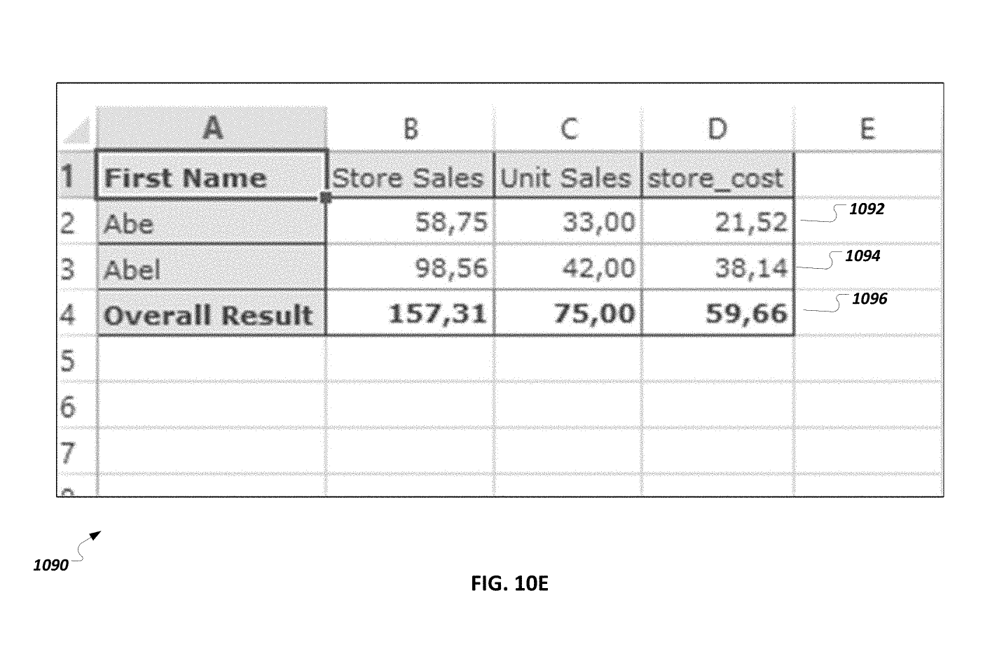

FIG. 10A is a block diagram 1000 illustrating a client workflow. In a first phase 1002, an open data source dialog 1004 is configured to call a system browse service 1006 to obtain information about data sources available in a particular system.

FIG. 10B is an example user interface 1040 for selecting a data source. The user interface 1040 can be the open data source dialog 1004 shown in FIG. 10A. The user interface 1040 can be configured to call a system browse service to obtain information about data sources available in a particular directory 1042 of a particular system. The system browse service can return information about data sources that are included in the directory. The user interface 1040 can be configured to present a representation of the directory 1042 and, in association with the representation of the directory 1042, a presentation name of each data source included in the directory. For example, a BICS_FOODMART data source 1044 is shown as being included in the directory 1042. The user interface 1040 can be configured to enable the user to select a particular data source (e.g., the data source 1044). The user interface 1040 can be configured to identify a data source description associated with the selected data source in the information about data sources returned from the system browse service.

Referring again to FIG. 10A, as illustrated by an arrow 1008, a system description and a data source description obtained using the system browse service 1006 can be provided to and used by a user interface 1010 to call a model service 1012 to obtain model information associated with the selected data source. The user interface 1010 can be used to display and modify the model information.

FIG. 10C is an example user interface 1050 for displaying model information. The user interface 1050 can be used to display model information for a selected data source. The model information can be obtained by calling a model service. The user interface 1050 can be configured to present model information obtained from the model service. For example, for a data source 1052, information about measures 1054, dimensions 1056, rows 1058, and columns 1060 can be displayed. The user can select an item of model information to view more detailed information or to do other actions, such as to create a filter, as described below. For example, the user can select a first name dimension 1062.

Referring again to FIG. 10A, the user interface 1010 can enable the user to view a user interface 1014 to show a list of values for a selected entity (e.g., dimension) of the model presented in the user interface 1010. The user interface 1014 can be configured to call a value help service 1016 to obtain the values for the selected entity. As respectively indicated by arrows 1018 and 1020, a system description and data source description information obtained from the system browse service 1006 and data source information obtained from the model service 1012 (e.g., a description of a selected model entity, such as a dimension) can be provided to the value help service 1016.

FIG. 10D is an example user interface 1070 for selecting one or more values. The user interface 1070 may be displayed, for example, in response to a user selecting an item of model information, such as a dimension, and then selecting a user interface control to request a filter operation. A user interface 1072 may be displayed in response to the request for the filter operation. The user interface 1070 can be displayed on top of the user interface 1072 to enable the user to select one or more values to be used in the filter. For example, the user can select a first name 1074 and a first name 1076.

Referring again to FIG. 10A, as illustrated by an arrow 1022, the user interface 1010 can obtain value information about value(s) the user has selected using the user interface 1014. The value information about the selected value(s) can be provided to the user interface 1010 (or to a program that created the user interface 1014), by the user interface 1014, for example. The selected values can be used to modify a model description obtained from the model service 1012, to create a modified model description. The user interface 1010 (or another program) can cause a user interface 1024 to be displayed, for presenting data, such as in a chart, that is associated with the modified model description. The user interface 1024 (or a program that created the user interface 1024) can call a result set service 1026 to obtain the data to present in the user interface 1024. As indicated by an arrow 1028, the modified model description can be obtained from the model service 1012 (or from the user interface 1010 or a program that created the user interface 1010) and provided to the result set service 1026.

FIG. 10E is an example user interface 1090 for displaying data from a result set. The user interface 1090 displays data in rows 1092, 1094, and 1096. The user interface 1090 (or a program or procedure that created the user interface 1090) can call a result set service to obtain data from the result set. A request can be sent to the result set to get structure information that indicates a layout of data represented by the result set. The structure information can indicate how many rows and columns of data are represented by the result set, for example.

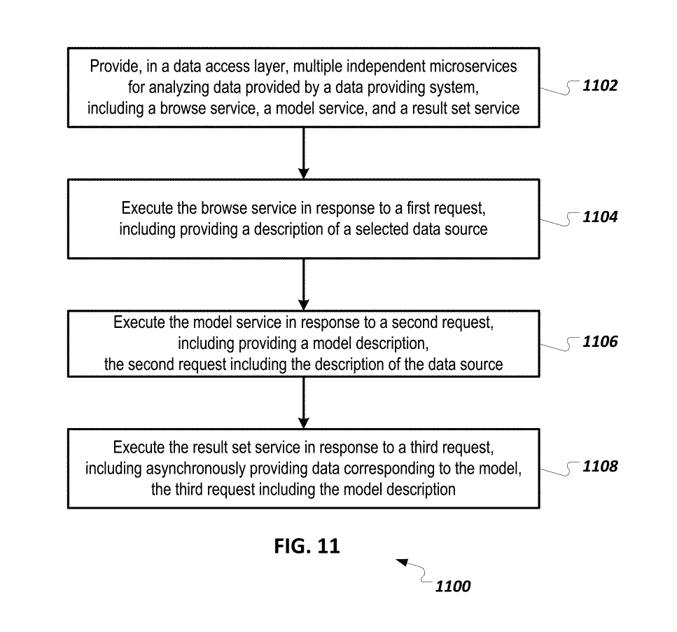

FIG. 11 is a flowchart of an example method 1100 for using microservices to analyze a data source. It will be understood that method 1100 and related methods may be performed, for example, by any suitable system, environment, software, and hardware, or a combination of systems, environments, software, and hardware, as appropriate. For example, one or more of a client, a server, or other computing device can be used to execute method 1100 and related methods and obtain any data from the memory of a client, the server, or the other computing device. In some implementations, the method 1100 and related methods are executed by one or more components of the system 100 described above with respect to FIG. 1. For example, the method 1100 and related methods can be executed by the server 102 of FIG. 1.

At 1102, a set of multiple independent microservices are provided, in a data access layer, for analyzing data provided by a data providing system. The multiple independent microservices include a browsing service that enables selection of a data source included in the data providing system, a model service that enables viewing and modifying a model of the data source, and a result set service that enables retrieval of data from the data source in accordance with the model. Each independent microservice can be configured to not execute any other independent microservice and to use data in a common format. Using data in a common format can include a first microservice using, as an input, an output generated by a second microservice.

The browsing service can enable searching for the data source in the data providing system. The browsing service can be configured to accept one or more filters to be used when searching for the data source. The results of the search can be provided asynchronously.

The multiple independent microservices can be configured to use an input handler that enables input to be provided to another microservice. The multiple independent microservices can include a value help service that provides values of an entity of the model. The entity can be, for example, a dimension of the data source. The value help service can enable selection of a subset of values that can be used, for example, to modify a model description.

At 1104, the browsing service is executed in response to a first request, including the providing of a description of a selected data source.

At 1106, the model service is executed, in response to a second request, including the providing of a model description. The second request includes the description of the selected data source.

At 1108, the result set service is executed, in response to a third request, including the asynchronous providing of data corresponding to the model description. The third request includes the model description. The first, second, and third requests can be received from a same client. The data corresponding to the model description can be asynchronously provided to the client.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer implemented method comprising:
providing, in a data access layer, a set of multiple independent microservices for analyzing data provided by a data providing system, including a browsing service that enables selection of a data source included in the data providing system, a model service that enables viewing and modifying a model of the data source, and a result set service that enables retrieval of data from the data source in accordance with the model;
executing, in response to a first request, the browsing service, including providing a description of a selected data source;
executing, in response to a second request, the model service, including providing a model description, the second request including the description of the selected data source; and
executing, in response to a third request, the result set service, including asynchronously providing data corresponding to the model description, the third request including the model description.

2. The computer-implemented method of claim 1, wherein each independent microservice is configured to not execute any other independent microservice.

3. The computer-implemented method of claim 1, wherein each independent microservice is configured to use data in a common format.

4. The computer-implemented method of claim 1, wherein a given microservice is configured to use an input handler that enables input to be provided to the given microservice.

5. The computer-implemented method of claim 1, wherein the browsing service enables searching for the data source in the data providing system.

6. The computer-implemented method of claim 5, wherein the browsing service is configured to accept one or more filters to be used when searching for the data source.

7. The computer-implemented method of claim 5, wherein results of the search are provided asynchronously.

8. The computer-implemented method of claim 1, wherein the first, second, and third requests are received from a same client.

9. The computer-implemented method of claim 1, wherein the multiple independent microservices include a value help service that provides values of an entity of the model.

10. The computer-implemented method of claim 9, further comprising executing, in response to a fourth request, the value help service, including providing the values of the entity to enable selection of a subset of the provided values, the fourth request including a description of the entity; and wherein the third request includes a modified model description modified based on the subset of the provided values;

11. The computer-implemented method of claim 9, wherein the entity is a dimension of the data source.

12. A system comprising:
one or more computers; and
a computer-readable medium coupled to the one or more computers having instructions stored thereon which, when executed by the one or more computers, cause the one or more computers to perform operations comprising:
providing, in a data access layer, a set of multiple independent microservices for analyzing data provided by a data providing system, including a browsing service that enables selection of a data source included in the data providing system, a model service that enables viewing and modifying a model of the data source, and a result set service that enables retrieval of data from the data source in accordance with the model;
executing, in response to a first request, the browsing service, including providing a description of a selected data source;
executing, in response to a second request, the model service, including providing a model description, the second request including the description of the selected data source; and
executing, in response to a third request, the result set service, including asynchronously providing data corresponding to the model description, the third request including the model description.

13. The system of claim 12, wherein each independent microservice is configured to not execute any other independent microservice.

14. The system of claim 12, wherein each independent microservice is configured to use data in a common format.

15. The system of claim 12, wherein a given microservice is configured to use an input handler that enables input to be provided to the given microservice.

16. The system of claim 12, wherein the browsing service enables searching for the data source in the data providing system.

17. A computer program product encoded on a non-transitory storage medium, the product comprising non-transitory, computer readable instructions for causing one or more processors to perform operations comprising:
providing, in a data access layer, a set of multiple independent microservices for analyzing data provided by a data providing system, including a browsing service that enables selection of a data source included in the data providing system, a model service that enables viewing and modifying a model of the data source, and a result set service that enables retrieval of data from the data source in accordance with the model;
executing, in response to a first request, the browsing service, including providing a description of a selected data source;
executing, in response to a second request, the model service, including providing a model description, the second request including the description of the selected data source; and
executing, in response to a third request, the result set service, including asynchronously providing data corresponding to the model description, the third request including the model description.

18. The computer program product of claim 17, wherein each independent microservice is configured to not execute any other independent microservice.

19. The computer program product of claim 17, wherein each independent microservice is configured to use data in a common format.

20. The computer program product of claim 17, wherein a given microservice is configured to use an input handler that enables input to be provided to the given microservice.
